(19) United States
(12) Patent Application Publication
(10) Pub. No.: US 2006/0287946 A1
(43) Pub. Date: Dec. 21, 2006

(54) Loss management system and method

(76) Inventor: Alvin David Toms, London (GB)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/238,306

(22) Filed: Sep. 29, 2005

(30) Foreign Application Priority Data
Jun. 16, 2005 (AU) 2005903140

(51) Int. Cl. G06Q 40/00

(52) U.S. Cl. 705/38

(57) ABSTRACT

Methods and systems of reducing risk of a credit provider making a loss for providing a good or service to a user include providing a first stage for evaluating applications to identify those with a high risk of the credit provider not being fully paid, providing the good or service to a successful applicant and providing a second stage for evaluating the use of or payment for the good or service by the user to identify the risk of not being fully paid. A loss management system having at least two stages is also described. The stages include a high risk application detection stage and a high risk usage or high risk payment behaviour detection stage.

### RELATED APPLICATIONS

This application claims priority to, and incorporates by reference, the entire disclosure of Australian Provisional Application No. 2005903140, filed on Jun. 16, 2005.

### FIELD OF THE INVENTION

The present invention relates to a system and method for reducing the risk of loss made by a credit provider due to fraud and/or bad debt.

### BACKGROUND TO THE INVENTION

Bad debt and fraud are serious problems for credit providers, such as telecommunications network operators, because payments for the services they supply are often made in arrears. This means that the operators are effectively lending their customers money to the value of the services they use in each bill cycle. Since this lending is unsecured, there is a natural tendency for customers who run up unmanageable debts to fail to make payment, thereby leaving the network operator with little chance of recovering the money they are owed and no choice but to bar the offenders from their network.

There are several systems on the market that aim to address this problem, usually by monitoring the pattern of usage of the services supplied to a subscriber, or the pattern of payments that the subscriber makes for those services. Unusual changes in such patterns can often be indicative of a decision by the subscriber not to pay for the services they are using, and hence to defraud the network operator, or a realisation that they will not be able to pay, and hence that they are going to default. In either case, systems that monitor usage or payment behaviour can be effective in detecting potential problems.

Such systems are not perfect however, and one of their major failings is that they rarely detect problems early enough for the operator to avoid incurring some kind of loss; by the time a subscriber has decided not to pay, or has a debt that they are unable to pay, there is little chance of the operator recovering the money they are owed. Although these losses can be minimised by introducing new technologies to improve response times, some delay in identifying problems will always occur with systems that analyse usage and payment behaviour.

Some systems on the market take a completely different approach to solving this problem. Rather than analysing usage and payment behaviour to detect problems they analyse applications for services instead. Such applications can contain obvious indications that a subscriber may be problematic. For example, an applicant may previously have been expelled from the network for a payment failure and may have reapplied in the hope that they would not be detected. Applications typically contain more subtle indicators that cannot be identified quite so simply, either because they are statistical in nature, or because they are intrinsically complex.

For example, a person with a low salary who has just moved into a new job, lives in rented accommodation, and has failed to provide a landline contact number on their application presents a particularly high risk both in terms of lacking an intention to pay for the services (failure to provide a landline contact number can represent a desire to minimise traceability, and people in rented accommodation can easily relocate), and inadvertently running up an unpayable debt (many companies operate a first in first out redundancy policy so being new in a job indicates heightened risk).

Although the preceding example may give the impression that it is possible to enumerate specific risk scenarios, in practice this can only be done in a small number of cases and a manual enumeration is not a practical way to design an effective application risk assessment system. Not only is such an enumeration unlikely to capture the complete set of risk indicators, it will also be unable to represent the true variations of risk that occur in the real world. The enumerated risk scenarios are simplistic discrete representations of specific types of risk clusters that are formulated in such as way that they are easily comprehensible to the human reader.

In practice, risk varies continuously as a function of the complex interactions of many variables and accurate rule based models of the true variation of risk are never comprehensible without massive simplification and performance loss. It is important to understand that this is not a failing of the models themselves but a reflection of the complexity of the variation of risk. For this reason, it is not possible to manually construct or design a practical accurate risk assessment system.

### SUMMARY OF THE PRESENT INVENTION

According to a first aspect of the present invention there is provided a method of reducing risk of a credit provider making a loss for providing a good or service (hereafter service) to a user, the method comprising providing a first stage for evaluating applications to identify those with a high risk of the credit provider not being fully paid for the service being applied for, providing the service to a successful applicant and providing a second stage for evaluating the use of or payment for the service by the user to identify the risk of not being fully paid for the service being provided.

In a preferred embodiment the first stage is conducted by a first predictive model. It is also preferred that the second stage is conducted by a second predictive model. Preferably the predictive models are trained from real application exemplar data or real usage or payment data, including real cases of fraud and bad debt.

Large quantities of such data are usually readily available and can consist either of applications that have been classified as bad (have been associated with a loss to a service provider), applications that have been classified as good (have been associated with a profit to a service provider), or both. There are a large variety of predictive models that can be used with such data, including neural networks, support vector machines, and decision trees. It is preferred that the predictive models estimate their parameters from exemplars or are based on parameters that are estimated from exemplars.

According to a second aspect of the present invention there is provided a loss management system having at least two stages, including a high risk application detection stage and a high risk usage or high risk payment behaviour detection stage.

In a preferred embodiment the high risk application detection stage comprises a predictive model with parameters that are estimated from exemplars. The exemplars comprise one or both of: applications that have turned out to be bad; and/or applications that have turned out to be good.

Typically the predictive model is a neural network trained using the exemplars.

It is preferred that the at least two stages are integrated into a single system.

In a preferred form the system is configured to assess the risk of loss from applications for unsecured credit.

According to a third aspect of the present invention there is provided a computer program for controlling a computing device to operate one or more of the methods defined above.

According to a fourth aspect of the present invention there is provided a computer program for controlling a computing device to operate as one or more of the loss management systems defined above.

According to a fifth aspect of the present invention there is provided a computer readable storage medium comprising a computer program as defined in the third or fourth aspects.

According to a sixth aspect of the present invention there is provided a system for reducing risk of a credit provider making a loss for providing a good or service (hereafter service) to a user, the system comprising means for evaluating applications to identify applications for a service in which there is a high risk of the credit provider not being paid for the service being applied for, means for providing the service to a successful applicant and means for evaluating the use of or payment for the service by the user to identify the risk of not being paid for the service being provided.

### SUMMARY OF THE DRAWINGS

In order to provide a better understanding of the present invention preferred embodiments will now be described by way of example only, with reference to the accompanying drawings in which:

FIG. 1 is a flow chart of a method according to one preferred form of the present invention;

FIG. 2 is a schematic diagram of a first predictive model according to one aspect of a preferred embodiment of the present invention;

FIG. 3 is a schematic diagram of a second predictive model according to another aspect of a preferred embodiment of the present invention; and

FIG. 4 is a schematic diagram of an apparatus for performing a preferred embodiment of the present invention.

### DETAILED DESCRIPTION OF PREFERRED EMBODIMENTS

Referring to FIG. 4, a loss management system 10 comprises an applicant analysis stage (AAS) 12 and a use/payment behaviour analysis stage (UAS) 14. The AAS 12 and UAS 14 are predictive models. The AAS 12 predictive model is designed to analyse applications for the provision of a (good or) service 13 provided on a credit basis. The UAS 14 predictive model is designed to analyse the actual use of the provided service or payment behaviour for the provided service. The AAS 12 and UAS 14 are typically implemented by programming one or more computers to operate as the predictive models.

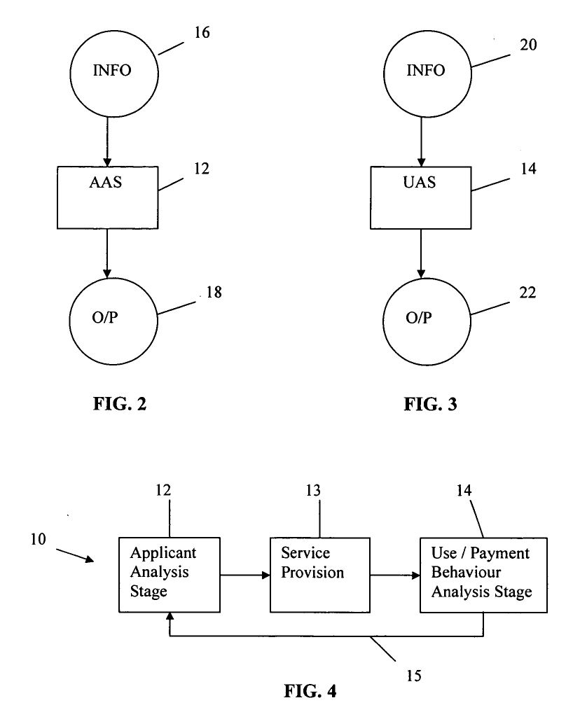

FIG. 2 shows the AAS 12 receiving information from an input 16 based on the application details. The AAS 12 processes this information to produce a result which indicates the risk of non payment if a decision is made to accept the applicant's application. The result is provided to the output 18 for use by the service provider to decide on whether to accept the application for credit and supply the service on a credit basis.

FIG. 3 shows the UAS 14 receiving information from an input 20 based on the use of the service and/or the payment behaviour of in relation to the service. The UAS 14 processes this information to produce another result which indicates the risk of non payment for the service provided. The other result is provided to the output 22 for use by the service provider to decide on whether to continue to provide the service.

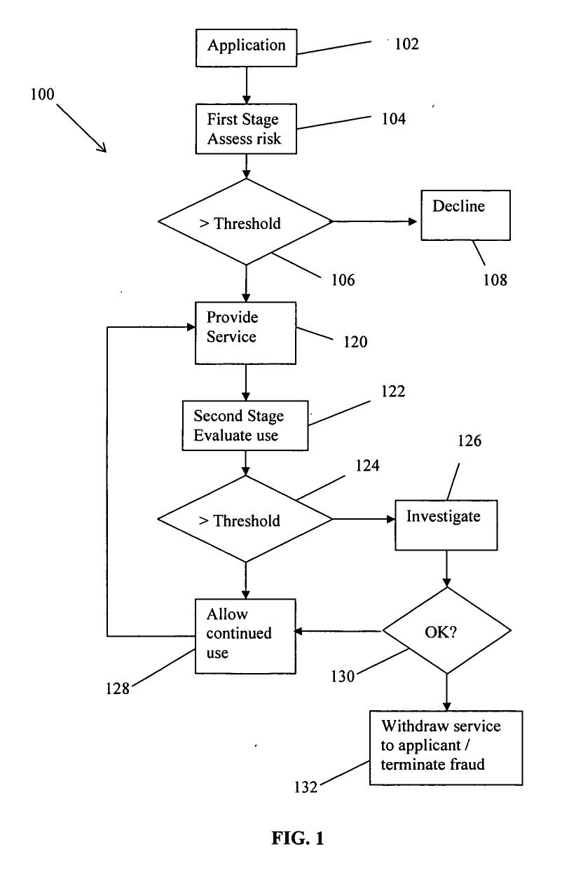

Referring to FIG. 1, a method 100 of use of the system 10 of FIGS. 2 to 4 is shown. The method 100 commences upon receipt 102 of an application for provision of the service, for example a person applying to become a mobile telephone subscriber. The details (e.g. name, address, income, length of time in the current job, length of time in the previous job, employer, previous service history, etc.) of the applicant and the type of service being requested from the application data are provided via input 16 to the AAS 12. The application data includes relevant details used by the service provider to consider whether to provide the service being requested. The AAS 12 assesses 104 the risk of non payment for the services being applied for from the application data. The assessment is provided by output 18. The form of assessment result might be binary in nature (e.g. acceptable/non-acceptable risk) or could be a rating (such as a probability of non-payment).

The assessed risk is then compared 106 to a threshold of acceptable risk. If the risk level is acceptable (for example 10% or less chance of non payment) then the service 13 is provided 120. If the assessed risk for that applicant is too high, then the application is declined 108 and providing the service on the terms applied for is refused. It is possible to reapply for the service under different terms, for example by lowering the amount of effective credit being requested.

While the service is being provided 120 an assessment is made on whether to continue to provide the service. This is conducted 122 by the UAS 14, which evaluates the payment history and/or usage characteristics, which are provided to input 20. This evaluation is provided by output 22.

The evaluation is then compared 124 to a threshold of acceptable risk. If the risk level is acceptable (for example 10% or less chance of non payment/fraudulent use) then the service is allowed to continue 128. In this event the process reverts to step 120. If the evaluation indicates a risk of non-payment and/or fraud, an investigation may be conducted 126. If the use is acceptable (checked at 130) then the service is continued at 128 and then 120. The service provider may decide to modify the terms of the service provision, for example by limiting the extent of use of the service, which effectively lowers the credit being provided. If however the use or payment history is not acceptable (again checked at 130), then the provision of the service is terminated 132.

The AAS 12 could use the well known nearest neighbour algorithm for classification and regression as the predictive model to produce risk assessments. Such an approach would not be desirable, however, because it does not derive parameters from its exemplar data that represent its most salient features but simply memorises the exemplar data and compares new applications to it. This means that a nearest neighbour based application assessment system would have vast storage and computational requirements that are not consistent with the needs of the present invention. Regardless of whether only good, only bad, or both types of exemplars are available, there are predictive models that can be used for risk assessment that can be created from them that are well known in the art.

For example, if both good and bad exemplars are available, the multilayer perceptron neural network is ideally suited to operate as the predictive model. It can easily be trained on exemplar data using standard neural network training algorithms. Similarly, if only bad exemplars are available, a density estimator can be configured as a novelty detector and used as a predictive model. The parameters of a density estimator can easily be estimated from exemplar data using standard maximum likelihood parameter estimation techniques. The predictive model may learn offline or online, or may use a combination of both—that is whether a model's parameters are frozen prior to assessing applications or whether the model continually learns as it does so. Online training is where the model is updated continually and whenever an application goes bad. In this case there is no concept of a well defined set of training data or a well defined point in time when training takes place.

The predictive model has parameters that are estimated from exemplars. The data itself is not intended to be the model. The word ‘exemplars’ is used, rather than the more common ‘historical data’, because the latter implies that there is a fixed set of old data from which the model is produced. The exemplars are not a set, which are predefined and fixed in some way. The phrase ‘predictive model’ is a standard one in the technical literature.

Even though the AAS 12 detects suspicious applications for services that might indicate a high risk of payment failure if the applications are accepted, not all bad applications can be detected by such a system nor will such a system ever be able to detect all bad applications regardless of the sophistication of the technology that it uses, not least because a good subscriber may go bad due to unforeseeable changes of circumstance.

For this reason the UAS 14 detects suspicious usage or payment behaviour that might indicate that a payment failure is imminent but usually does so too late to prevent some loss. For example, a subscriber that realises that they are about to move to new rented accommodation might realise that they will be difficult to trace. Believing that they can successfully avoid paying their next bill, they may make a large volume of high cost calls to mobile, international, or premium rate destinations.

By examining calling behaviour, the UAS can detect changes such as these, which could not possibly be identified by the AAS, but which can be indicators that a payment default may occur. Similarly, if someone who has regularly paid their bills in full and on time suddenly starts to make partial payments and those payments arrive late, it may be indicative of a change in the person's circumstances that is making it difficult for them to make payments, and which might ultimately cause a payment default.

The UAS may accept data feeds from transaction processing systems that will provide information on usage in the form of transaction reports that are usually generated for the purposes of billing and system monitoring but may also be used for usage monitoring and analysis by the present invention. The UAS may also accept a data feed from a billing system so that it can receive updated information on payments made, payments pending, payment history, provisioning details, and a large range of other information.

In a preferred embodiment of the invention, the AAS 12 and UAS 14 are integrated into a single system so that the high risk application and high risk usage or high risk payment behaviour detection components can be configured through a single user interface, and so that high risk application alerts and high risk usage or payment behaviour alerts can be viewed and processed through a single user interface.

Integration can also allow information on subscribers that turn out to be bad or are detected to be bad by the UAS 14, or are believed to be good, to be fed back by feedback link 15 to the AAS 12, or information on the performance of the AAS 12 or UAS 14 can be fed back to either of the components.

The effects of the invention go far beyond the additive effects of operating the first and second stages simultaneously but the combination represents a true synergy that offers a performance uplift beyond what would be expected, and offers the service providers that employ the system a variety of new business options. For example, consider a provider who has only the high risk application detection stage of the system, which rejects applications considered to represent a high risk of turning bad.

Since the provider has no usage and payment behaviour monitoring system to identify bad subscribers early, the loss associated with each will be large, perhaps as much as $1,000. Consider now that the provider sets up loss management system in accordance with the present invention. Since each bad subscriber will now be caught much more quickly, they will cost the company less, perhaps $100. This means that the company has reduced its losses. The alternative interpretation of this saving, however, is that the company's exposure to post-acceptance risk is now only one tenth what it was previously and hence the company can afford to accept ten times as many potentially bad subscribers as it previously did.

This means that the proportion of applications that the company accepts through the high risk application detection stage can be increased, increasing opportunities for growth while maintaining the original level of risk. The conversion of the company's loss management system into one that is consistent with the present invention therefore opens up a wide a variety of new business opportunities ranging from pure loss minimisation to growth maximisation. The choice that a particular company will make will depend on the prevailing conditions in their target market. In a saturated telco market such as Europe, for example, a company will choose to minimise losses and not attempt to increase their growth rate. In a rapidly expanding telco market such as East Asia, a company will choose to maximise growth to capture as great a share of the expanding market as possible.

Interactions between the usage and payment monitoring stage and the application stage also happen in reverse. Consider, for example, a company that operates a usage and payment monitoring system but not an application assessment system. Such a company may operate in an environment where one percent of subscribers turn out to be bad. When, in accordance with the present invention, an application assessment system is installed, many potentially bad subscribers will be detected at the application stage, reducing the number of subscribers that turn bad to perhaps 0.1 percent. The most obvious effect of this reduction is that the provider's losses will fall and their profitability will increase.

Alternatively, and more subtly, the provider can choose to trade the reduction in risk exposure obtained at the application stage off against increased risk exposure at the usage stage by improving quality of service, perhaps by offering higher value services to riskier subscribers, increasing credit limits, or offering more flexible payment options. These changes may indirectly produce more growth as the provider becomes more attractive than competitors or may directly increase revenue when potentially risky subscribers turn out to be profitable.

The interaction of these components that occurs when they are deployed in combination provides a business with a wide spectrum of options, including increasing their rate of growth, increasing their profitability, improving the quality of their services, and many others that cannot be obtained simply by upgrading or deploying either component in isolation.

Use of predictive models with parameters that are estimated using exemplar data are able to learn risk profiles using minimum storage and computation and hence systems that incorporate them are able to achieve their objectives on cheaper hardware making them more cost competitive as well as higher performing.

A preferred application area of the present invention is in the field of unsecured lending, where it has been found to produce the greatest performance benefits as compared to competing systems. There are a variety of reasons for this but one of the most important is that unsecured lenders tend to attract a preponderance of applicants who intend not to pay. The proportion of losses that are due to applicants who intend to pay but find themselves unable to do so is therefore smaller for unsecured lenders than secured lenders.

This alone tends to produce an uplift in performance because people who intend to pay are self selecting; if it is easy to predict that someone will be unable to make repayments, they usually do not apply. Of the applicants who intend to pay, this leaves only the applicants for whom it is difficult to predict non-payment. The proportion of such applicants is lower in the field of unsecured lending because of the preponderance of applicants who intend not to pay meaning that it is generally easier to identify high risk applications for unsecured credit than for secured credit.

The importance of this realisation is further strengthened by the fact that bad applications actually cost the supplier of unsecured credit but not the supplier of secured credit. Not only is there greater potential to reduce losses in the unsecured credit industry than the secured credit industry but the commercial imperative for doing so is also greater. Furthermore, the primary concern for applicants that do not intend to pay is that they cannot be positively identified and traced. This causes them to leave characteristic signatures in their application details that are difficult to describe, but can be learnt from exemplars by a predictive model.

Modifications and variations may be made to the present invention without departing form the inventive concept. Such modifications and variations are intended to fall within the scope of the present invention, the nature of which is to be determined from the foregoing description and appended claims.

1. A method of reducing risk of a credit provider making a loss for providing a good or service to a user, the method comprising:
providing a first stage for evaluating applications to identify those with a high risk of the credit provider not being fully paid;
providing the good or service to a successful applicant; and
providing a second stage for evaluating the use of or payment for the good or service by the user to identify the risk of not being fully paid.

2. A method according to claim 1, wherein the first stage is conducted by a first predictive model.

3. A method according to claim 1, wherein the second stage is conducted by a second predictive model.

4. A method according to claim 2, wherein the predictive model is trained from real application exemplar data and real cases of fraud and bad debt.

5. A method according to claim 4, wherein the data consists either of applications that have been classified as bad.

6. A method according to claim 4, wherein the data consists of applications that have been classified as good.

7. A method according to claim 4, wherein the data consists applications that have been classified as bad.

8. A method according to claim 4, wherein the data consists of applications that have been classified as good and applications that have been classified as bad.

9. A method according to claim 3, wherein the predictive model is trained from real application exemplar data and real cases of fraud and bad debt.

10. A method according to claim 2 wherein the first predictive model includes one of a neural network, a support vector machine, or a decision tree.

11. A method according to claim 10, wherein the first predictive model estimates its parameters from exemplars or is based on parameters that are estimated from exemplars.

12. A method according to claim 3 wherein the second predictive model includes one of a neural network, a support vector machine, or a decision tree.

13. A method according to claim 12, wherein the second predictive model estimates its parameters from exemplars or are based on parameters that are estimated from exemplars.

14. A loss management system having at least two stages, comprising
a high risk application detection stage, and
a high risk usage or high risk payment behaviour detection stage.

15. A system according to claim 14, wherein the high risk application detection stage comprises a predictive model

16. A system according to claim 15, wherein the predictive model has parameters that are estimated from exemplars.

17. A system according to claim 16, wherein the exemplars consist of applications that have turned out to be bad.

18. A system according to claim 16, wherein the exemplars consist of applications that have turned out to be good.

19. A system according to claim 16, wherein the exemplars consist of applications that have turned out to be good and of applications that have turned out to be bad.

20. A system according to claim 15, wherein the predictive model is a neural network trained using the exemplars.

21. A system according to claim 14, wherein the at least two stages are integrated into a single system.

22. A system according to claim 14, wherein the applications are for unsecured credit.

23. A computer program for controlling a computing device to operate according to the method defined in claim 1.

24. A computer program for controlling a computing device to operate as the loss management systems defined in claim 14.

25. A computer readable storage medium comprising a computer program as defined in claim 23.

26. A computer readable storage medium comprising a computer program as defined in claim 24.

27. A system for reducing risk of a credit provider making a loss for providing a good or service to a user, the system comprising:
means for evaluating applications to identify those which have a high risk of the credit provider not being fully paid;
means for providing the good or service to a successful applicant; and
means for evaluating the use of or payment for the good or service by the user to identify the risk of not being fully paid.
